(19) United States
(12) Patent Application Publication
(10) Pub. No.: US 2025/0015537 A1
(43) Pub. Date: Jan. 9, 2025

(54) ELECTRICAL CONNECTOR HOUSING AND ELECTRICAL CONNECTOR

(71) Applicant: Tyco Electronics (Shanghai) Co., Ltd., Shanghai (CN)

(72) Inventors: Wenfang (Felix) Zhang, Shanghai (CN); Tongbao (Tim) Ding, Shanghai (CN); Yongjian (Justin) Huang, Shanghai (CN); Zhimin Zhang, Shanghai (CN); Chunjie Hu, Shanghai (CN)

(73) Assignee: Tyco Electronics (Shanghai) Co., Ltd., Shanghai (CN)

(21) Appl. No.: 18/765,521

(22) Filed: Jul. 8, 2024

(30) Foreign Application Priority Data
Jul. 6, 2023 (CN) 202310826483.X

(51) Int. Cl. H01R 13/629

(52) U.S. Cl. CPC H01R 13/62938; H01R 13/62944; H01R 13/62955

(57) ABSTRACT

An electrical connector housing comprises a body, a locking portion, and a securing portion. The body defines a receiving cavity adapted to receive a terminal, and an insertion hole adapted to receive a conductive connecting element, such that the conductive connecting element electrically connects the terminal. The locking portion is movably connected to the body and movable from a first position to a second position after the conductive connecting element is inserted. In the second position, a wedge-shaped structure arranged on at least one of the body or the locking portion is adapted to increase a retention force between the terminal and the conductive connecting element. The securing portion selectively secures the locking portion in the second position.

### CROSS-REFERENCE TO RELATED APPLICATION

This application claims the benefit of Chinese Patent Application No. 202310826483.X filed on Jul. 6, 2023 in the State Intellectual Property Office of China, the whole disclosure of which is incorporated herein by reference.

### FIELD OF THE INVENTION

Embodiments of the present disclosure relate to the field of electronic connection accessories and, more particularly, to an electrical connector housing and an electrical connector with high retention force.

### BACKGROUND

An electrical connector is a device that connects two conductors of a circuit so that current or signals can flow from one conductor to the other. An electrical connector is also a system that provides a detachable interface to connect two sub-electronic systems, and further, is a component used to make electrical connections between circuits or electronic machines.

Existing electrical connectors generally require a relatively large insertion force in order to achieve a high retention force, which is not convenient for production line operations. Moreover, there is a problem that need to be solved is to ensure the reliable connection performance of the product when facilitating the production line operation, such as reducing the insertion force.

### SUMMARY

According to an embodiment of the present disclosure, an electrical connector housing comprises a body, a locking portion, and a securing portion. The body defines a receiving cavity adapted to receive a terminal, and an insertion hole adapted to receive a conductive connecting element, such that the conductive connecting element electrically connects the terminal. The locking portion is movably connected to the body and movable from a first position to a second position after the conductive connecting element is inserted. In the second position, a wedge-shaped structure arranged on at least one of the body or the locking portion is adapted to increase a retention force between the terminal and the conductive connecting element. The securing portion selectively secures the locking portion in the second position.

### BRIEF DESCRIPTION OF THE DRAWINGS

The invention will now be described by way of example with reference to the accompanying Figures, of which:

FIG. 1 shows a schematic view of an electrical connector according to an embodiment of the present invention.

FIG. 2(a) shows a schematic view of the assembly of an electrical connector according to an embodiment of the present invention.

FIG. 2(b) shows another schematic view of the assembly of an electrical connector according to an embodiment of the present invention.

FIGS. 3(a) and 3(b) show schematic views of the locking portion according to an embodiment of the present invention.

FIG. 4 shows a cross-sectional schematic view of the electrical connector in the first state according to an embodiment of the present invention.

FIG. 5 shows an enlarged schematic view of the area M in FIG. 4.

FIG. 6 shows a cross-sectional schematic view of the electrical connector in the second state according to an embodiment of the present invention.

FIG. 7 shows an enlarged schematic view of the area N in FIG. 6.

FIG. 8 shows another cross-sectional schematic view of the electrical connector in the second state according to an embodiment of the present invention.

FIG. 9 shows an enlarged schematic view of the area P in FIG. 8.

FIG. 10 shows another cross-sectional schematic view of the electrical connector according to an embodiment of the present invention.

FIG. 11 shows an enlarged schematic view of the area Q in FIG. 10.

FIG. 12 shows an enlarged schematic view of the area R in FIG. 10.

FIG. 13 shows an enlarged schematic view of the area S in FIG. 10.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As mentioned above, existing electrical connectors have technical defects of high insertion forces and low retention forces. To address these defects, the disclosed embodiments propose an electrical connector housing and an electrical connector having high retention force, which can reduce the insertion force and ensure the connection reliability of the products at the same time, enabling the products to withstand higher vibration and mechanical impact.

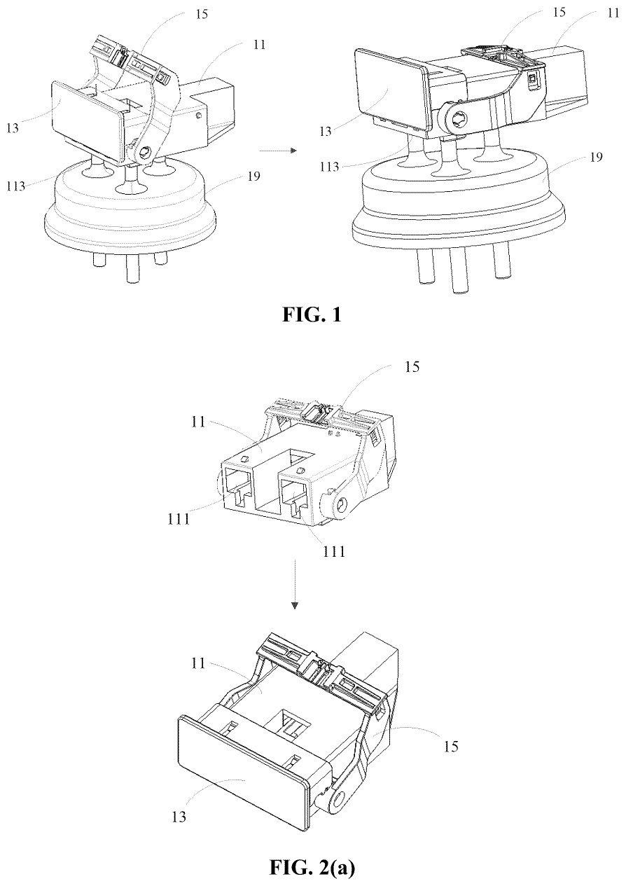

As shown in FIGS. 1-13, an embodiment of this disclosure proposes an electrical connector, which comprises a body 11, a locking portion 13, a securing portion 15, and a terminal 17. The body 11 further comprises a receiving cavity 111 and an insertion hole 113. The receiving cavity 111 is adapted to accommodate the terminal 17, and the insertion hole 113 is adapted for the insertion of, or to receive, a conductive connecting element 19, such that the conductive connecting element 19 electrically connects the terminal 17.

Specifically, the locking portion 13 is movably sleeved to the body 11. The locking portion 13 is adapted to be operated to move from the first position (shown in the left of FIG. 1) to the second position (shown in the right of FIG. 1) after the conductive connecting element 19 is inserted, to compress inward with a wedge-shaped structure arranged on the body 11 or the locking portion 13, thereby increasing the retention force between the terminal 17 and the conductive connecting element 19. The securing portion 15 secures the locking portion 13 to the second position when the locking portion 13 is moved to the second position.

Preferably, in some examples, the securing portion 15 is a linkage structure. The linkage structure is rotatably connected to the body 11 and geared to the locking portion 13. After the conductive connecting element 19 is inserted, the linkage structure 15 is operable to rotate from a third position (shown in the left of FIG. 1) to the fourth position (shown in the right of FIG. 1), thereby driving the locking portion 13 to move from the first position to the second position. The linkage structure with gear connection requires less operating force and is convenient for users to use.

In some examples, the linkage structure 15 is a U-shaped linkage structure, with its first and second ends rotatably connected to the two side walls of the body 11. The U-shaped linkage structure has the advantages of good stability, easy operation, and space saving.

In other examples, the locking portion 13 can be moved from the first position to the second position by a force exerted to it from the outside. Then the securing portion 15 secures the locking portion 13 to the body 11, and thus fixes the locking portion 13 at the second position. The securing portion 15 may not participate in the movement process of the locking portion 13 from the first position to the second position, and therefore it has a simpler structure and lower manufacturing cost.

FIG. 1 is a schematic diagram of the structure of an electrical connector according to an embodiment of the present disclosure, wherein the locking portion 13 of the electrical connector is located at the first position in the left of FIG. 1. The locking portion 13 exerts no force on the terminal or the conductive connecting element when it is at the first position, and correspondingly, the linkage structure 15 is located at the third position. When the linkage structure 15 is operated to be pressed down, the linkage structure 15 moves from the third position to the fourth position and drives the locking portion 13 to move forward in a straight line. The wedge-shaped structure arranged inside the body 11 or the locking portion 13 is compressed, and then acts on the terminal 17 and the connecting element 19 inside, thereby improving the retention force of the electrical connector.

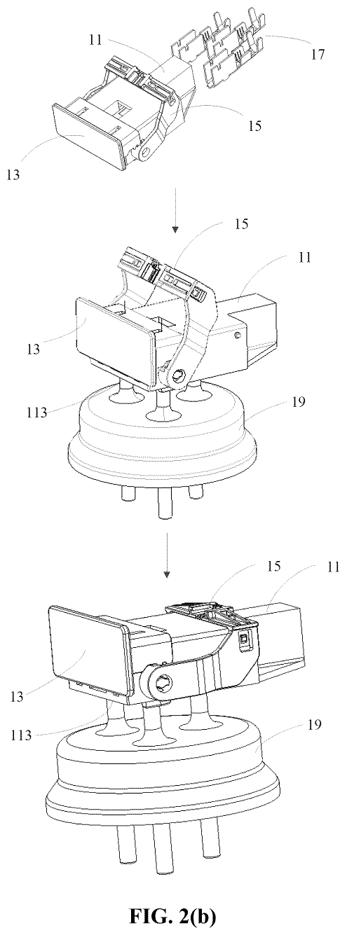

FIG. 2(a) and FIG. 2(b) are schematic diagrams of the assembly of an electrical connector at the production side and the client side, respectively. As shown in FIG. 2(a), the assembly process of the electrical connector at the production side is as follows. First, the linkage structure 15 is installed on the body 11. Next, the locking portion 13 is sleeved to the body 11 and simultaneously the first gear structure on the locking portion 13 is engaged with the second gear structure on the linkage structure 15. As shown in FIG. 2(b), the assembly process of the electrical connector at the client side is as follows. Firstly, the terminal 17 is inserted into the receiving cavity 111 of the electrical connector housing which is pre-installed at the production side, and at this time, the locking portion 13 is located at the first position and the linkage structure 15 is located at the third position. Secondly, the conductive connecting element 19 is inserted into the insertion hole 113. Finally, the linkage structure 15 is pressed down to the fourth position, and the linkage structure 15 drives the locking portion 13 to move from the first position to the second position. During the moving process, the internal width of the wedge-shaped structure located in the body 11 or the locking portion 13, which corresponds to the connecting position between the terminal 17 and the conductive connecting element 19, is continuously reduced, thereby compressing the terminal 17 and the conductive connecting element 19 inward, and increasing the retention force between the terminal and the conductive connecting element.

It should be noted that the assembly diagrams of FIGS. 2(a) and 2(b) are only exemplary usage instructions of the present disclosure and are not intended to limit the disclosure. For example, the electrical connector may also be provided to the user after assembly with the terminal is completed at the production side. Moreover, the application scope of the present disclosure is not limited to the conductive connecting element shown in the figures, but is applicable to any suitable application scenarios of electrical connection.

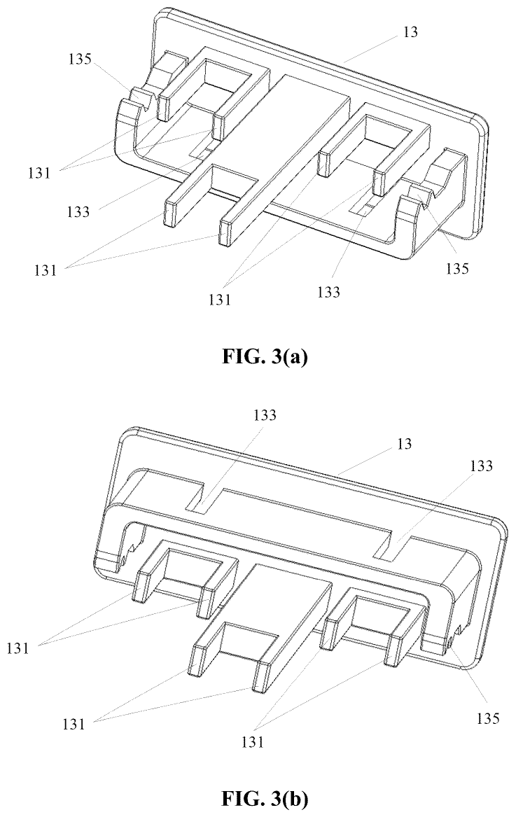

FIG. 3(a) and FIG. 3(b) are schematic diagrams of the locking portion of an electrical connector from different perspectives. The locking portion 13 includes an insertion portion 131, a rectangular groove 133, and a gear connection portion 135. The locking portion 13 is inserted into the receiving cavity 111 of the body 11 by the insertion portion 131 and installed on the body. The locking portion 13 is snap-connected to a protrusion 117 of the body 11 by the rectangular groove 133. The locking portion 13 is geared to the linkage structure 15 by the gear connection portion 135.

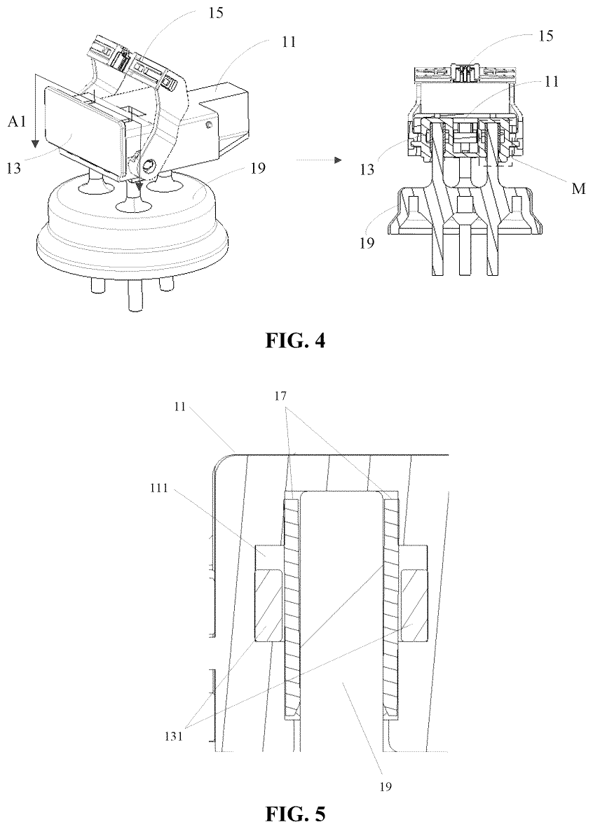

As shown in FIG. 4, an embodiment of the present disclosure presents a cross-sectional schematic diagram of an electrical connector in the first state, wherein the corresponding cross-sectional line is A1. The first state of the electrical connector is a state when the locking portion 13 is at the first position and the linkage structure 15 is at the third position. FIG. 5 is an enlarged schematic diagram of the area M in FIG. 4. It is illustrated schematically in FIG. 4 and FIG. 5 that when the electrical connector is in the first state, there is a gap between the locking portion 13 and the terminal, and the locking portion 13 does not apply a compressing force to the terminal 17 and the conductive connecting element 19.

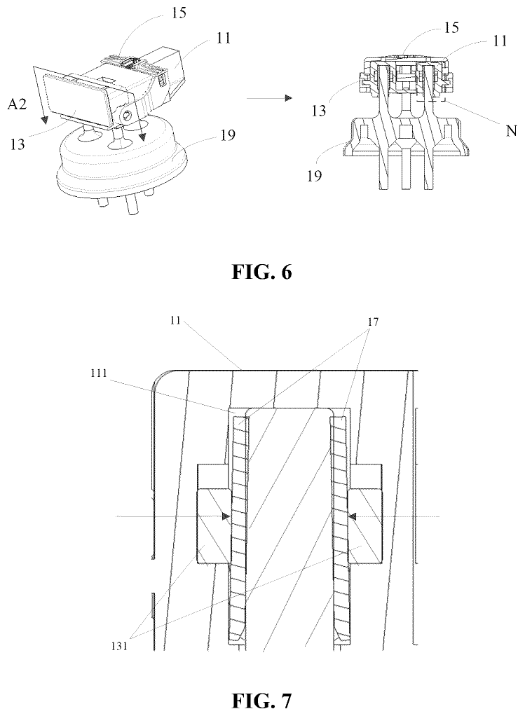

As shown in FIG. 6, an embodiment of the present disclosure presents a cross-sectional schematic diagram of an electrical connector in the second state, wherein the corresponding cross-sectional line is A2. The second state of the electrical connector is a state when the locking portion 13 is at the second position and the linkage structure 15 is at the fourth position. FIG. 7 is an enlarged schematic diagram of the area N in FIG. 6. It is illustrated schematically in FIGS. 6 and 7 that when the electrical connector is in the second state, the locking portion 13 is connected to the terminal and applies an inward compressing force to the terminal 17 and the conductive connecting element 19 (as indicated by the arrow in FIG. 7).

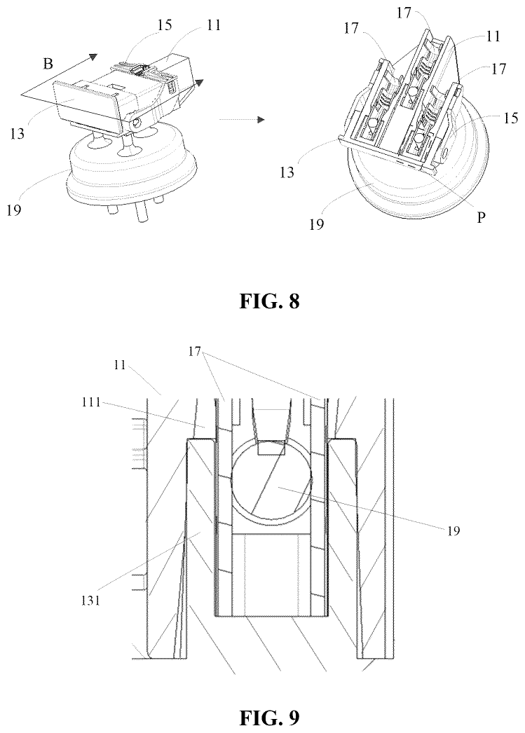

As shown in FIG. 8, an embodiment of the present disclosure presents another cross-sectional schematic diagram of an electrical connector in the second state, wherein the corresponding cross-sectional line is B. FIG. 9 is an enlarged schematic diagram of the area Pin FIG. 8. In FIG. 9, the wedge-shaped structure is arranged inside the body 11, and its opening gradually gets wider along the outward direction. In FIG. 9, the internal width of the receiving cavity 111 gradually increases from top to bottom. When the locking portion 13 moves from the first position to the second position and the insertion portion 131 of the locking portion 13 gradually enters into the receiving cavity 111, as the width of the receiving cavity gradually decreases, the insertion portion 131 of the locking portion 13 undergoes elastic deformation due to compression, and applies an inward compressing force to the terminal 17. Further, the terminal 17 applies an inward compressing force to the conductive connecting element 19, thereby increasing the retention force between the terminal 17 and the conductive connecting element 19.

In other examples, the wedge-shaped structure is arranged on the locking portion 13, and the insertion portion 131 of the locking portion 13 is provided with a locking cavity. The opening of the locking cavity gradually gets wider along the outward direction. When the locking portion 13 moves from the first position to the second position, the width of the locking cavity, which corresponds to the connecting position between the terminal and the conductive connecting element, gradually decreases. The inner surface of the locking cavity applies an inward compressing force to the terminal 17, and then the terminal 17 applies an inward compressing force to the conductive connecting element 19, thereby increasing the retention force between the terminal 17 and the conductive connecting element 19.

Preferably, in some examples, the receiving cavity 111 and the insertion hole 113 are such configured that there is no insertion force between the conductive connecting element 19 and the terminal 17 during the insertion process of the conductive connecting element 19. That is, there is a gap reserved between the installed position of the terminal 17 in the receiving cavity 111 and the insertion hole 113. In other examples, the receiving cavity 111 and the insertion hole 113 are such configured that there is a small insertion force between the conductive connecting element 19 and the terminal 17 during the insertion process. That is, the installed position of the terminal 17 in the receiving cavity 111 is adjacent to or slightly overlaps with the insertion hole 113.

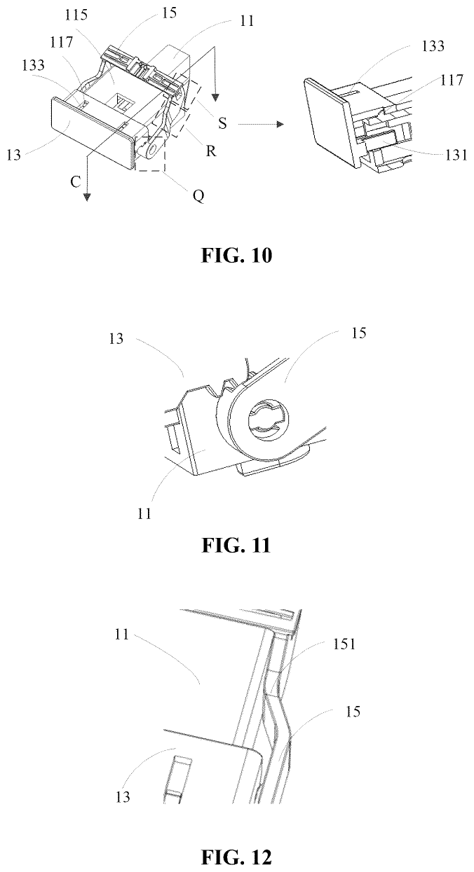

As shown in FIG. 10, another cross-sectional schematic diagram of an electrical connector is presented in an embodiment of the present disclosure, wherein the corresponding cross-sectional line is C. The first surface 115 of the body 11 is provided with a protrusion 117, and the locking portion is provided with a rectangular groove 133. The body 11 is snap-connected to the locking portion 13 at the first position by the protrusion 117 and the rectangular groove 133. In some examples, the length of the rectangular groove 133 is equal to the moving distance from the first position to the second position, and the rectangular groove 133 is configured to limit the moving trajectory of the locking portion 13 from the first position to the second position.

FIG. 11 is an enlarged schematic diagram of the area Q in FIG. 10. In some examples, as shown in FIG. 11, the linkage structure 15 is rotatably connected to the body 11 with a keying or linear structure. The linear structure can limit the installation direction and angle of the linkage structure, and avoid installation errors.

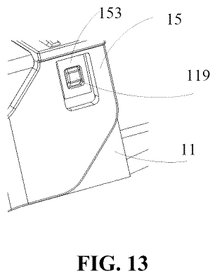

FIG. 12 is an enlarged schematic diagram of the area R in FIG. 10. FIG. 13 is an enlarged schematic diagram of the area S in FIG. 10. As shown in FIG. 12, in some examples, the linkage structure 15 includes a bending portion 151 with which the linkage structure is clamped to the body when at the third position. The inner width of the bending portion 151 is slightly smaller than the width of the body 11, allowing the linkage structure 15 to engage with the body 11 at the third position to avoid possible damage caused by the movement of the linkage structure during the transportation.

As shown in FIG. 13, in some examples, the linkage structure 15 includes a bayonet portion 153. When the linkage structure 15 is at the fourth position, it is connected to the body 11 by the buckle portion 153 and fix itself at the fourth position, thereby fixing the locking portion 13 at the second position. And the stable and high retention force is provided for the terminal and the conductive connecting element. In some examples, there are protruding structures 119 extending outwardly on both side walls of the body 11, and mounting holes 153 are provided at both ends of the linkage structure 15 to match the protruding structures 119.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector housing, comprising:
a body, including:
a receiving cavity adapted to receive a terminal, and
an insertion hole adapted to receive a conductive connecting element, such that the conductive connecting element electrically connects the terminal;
a locking portion movably connected to the body and movable from a first position to a second position after the conductive connecting element is inserted, in the second position, a wedge-shaped structure arranged on at least one of the body or the locking portion is adapted to increase a retention force between the terminal and the conductive connecting element; and
a securing portion selectively secures the locking portion in the second position.

2. The electrical connector housing according to claim 1, wherein the securing portion is a linkage rotatably connected to the body.

3. The electrical connector housing according to claim 2, wherein the linkage is rotatable from a third position to a fourth position after the conductive connecting element is inserted to drive the locking portion to move from the first position to the second position.

4. The electrical connector housing according to claim 3, wherein the linkage is connected to the locking portion by a geared connection.

5. The electrical connector housing according to claim 3, wherein the linkage includes a bending portion with which the linkage structure is clamped to the body when in the third position.

6. The electrical connector housing according to claim 3, wherein the linkage includes a bayonet portion by which the linkage is connected to the body when in the fourth position and fixes the locking portion at the second position.

7. The electrical connector housing according to claim 3, wherein the linkage is U-shaped linkage including a first end and a second end are rotatably connected to two side walls of the body.

8. The electrical connector housing according to claim 3, wherein the linkage is rotatably connected to the body with a keying structure limiting an installation orientation of the linkage relative to the body.

9. The electrical connector housing according to claim 1, wherein the receiving cavity and the insertion hole are adapted such that there is no contact between the conductive connecting element and the terminal when the conductive connecting element is inserted.

10. The electrical connector housing according to claim 1, wherein a first surface of the body defines a protrusion and the locking portion provided with a groove, and the body is connected to the locking portion at the first position by the protrusion and the groove.

11. The electrical connector housing according to claim 10, wherein the protrusion is snap-fit into the groove.

12. The electrical connector housing according to claim 10, wherein a length of the groove is equal to a moving distance from the first position to the second position.

13. The electrical connector housing according to claim 10, wherein the groove limits movement of the locking portion from the first position to the second position.

14. An electrical connector, comprising:
a housing, including:
a body defining a cavity adapted to receive a terminal, and an insertion hole adapted to receive a connecting element for electrically contacting the terminal;
a locking portion movably connected to the body and movable from a first position to a second position after the conductive connecting element is inserted, wherein the body and the locking portion are shaped such that, in the second position, a retention force between the terminal and the conductive connecting element is increased; and
a securing portion selectively securing the locking portion in the second position.

15. The electrical connector according to claim 14, wherein at least one of the locking portion or the body defines a wedge shaped adapted to bias the conductive terminal into contact with the connecting element with the locking portion in the second position.

16. The electrical connector according to claim 14, wherein the securing portion includes a linkage geared to the locking portion.

17. The electrical connector according to claim 16, wherein linkage is rotatably connected to the body, the linkage rotatable from a third position, to a fourth position after the conductive connecting element is inserted.

18. The electrical connector according to claim 16, wherein as the linkage is rotated from the third position to the fourth position, the locking portion is driven to move from the first position to the second position.

19. The electrical connector according to claim 14, further comprising a terminal inserted into the cavity of the body.

20. The electrical connector according to claim 19, wherein in the second position, the locking portion biases the terminal into conductive contact with connecting element.
